(19) United States
(12) Patent Application Publication
(10) Pub. No.: US 2008/0183811 A1
(43) Pub. Date: Jul. 31, 2008

(54) Collaborative Multi-User Method and System

(76) Inventors: Timothy W. Kotras, Waukesha, WI (US); Jeffrey Cavett, Greenfield, WI (US)

Correspondence Address: ABSOLUTE TECHNOLOGY LAW GROUP LLC, 135 W. WELLS ST., SUITE 518, MILWAUKEE, WI, 53203, US

(21) Appl. No.: 12/020,511

(22) Filed: Jan. 25, 2008

Related U.S. Application Data
(60) Provisional application No. 60/897,445, filed on Jan. 25, 2007.

(51) Int. Cl. G06F 15/16; G06F 3/048; G06F 17/30

(52) U.S. Cl. 709/203; 715/789; 707/200; 707/E17.005

(57) ABSTRACT

A method and system for facilitating collaborative task performance using client and host software configured to establish multiple user connections between client devices and a host computer, and to enable the host computer to accept input from multiple client devices to update a single user interface in real time reflect input from multiple users and facilitate collaborative tasks.

### CROSS-REFERENCE TO RELATED APPLICATION

This application claims the benefit of and priority to U.S. provisional application Ser. No. 60/897,445, filed on Jan. 25, 2007 and incorporated herein in its entirety.

### FIELD OF THE INVENTION

This invention relates generally to the field of Personal Area Networking (PAN) methods and systems and more specifically to a method and to allow a host computer to accept interactive input from multiple peripheral computer devices and display multi-user input on a user interface.

### BACKGROUND OF THE INVENTION

A typical computer accepts inputs from one mouse and one keyboard. The motherboard takes the electronic signals from these devices and translates them into signals that can be interpreted by special pieces of software called device drivers. Those devices drivers in turn send software commands to the operating system (like Microsoft Windows XP, Microsoft Vista, or Apple MAC OS X) which in turn create the mouse cursor's movement and entered keystrokes you see on a computer screen.

Currently, technology is available which allows a user to send a signal from a digital electronic device (e.g., a Personal Digital Assistant or cell phone) to a host computer to initiate or direct a function on a host computer by interacting with the operating system on the host computer. For example, a Bluetooth signal may be sent from a cell phone or remote control device to control the slides which appear on a user interface created in a Microsoft Power Point Presentation.

At Carnegie Mellon University, considerable research has been undertaken to explore how handheld devices such as telephones and digital electronic devices can be used by a single user to communicate with a host computer.

Additionally, software is commercially available which allows a remote user to connect to a personal computer acting as a host, and which allows the desktop view of the host to be displayed on the individual desktop of one or more client computers. A user connected to a client computer can transmit input to the host computer to perform a task or function on the host computer and to modify the computer interface. One example of a commercially available application of this technology is the GoToMeeting software which was marketed by Citrix Online of Santa Barbara, Calif. This product is designed to permit secure transmissions using high-security encryption and optional passwords to enable transmissions from a host computer passed through firewalls on client computers to allow simultaneous, non-interactive viewing of the host interface.

Software applications which are currently available also allow remote administration of a host computer by a client computer from a remote location on a network or over the Internet. Typically, such software allows a remote user to control a desk top computer from a separate location, and is often used by network administrators in business settings. Such software may allow the host computer to be serviced without disturbing the user of the computer.

The remote control software consists of two separate computer programs, a “host version” that is installed on the (host) computer to be controlled, and a “client version” that is installed on the controlling (client) computer. Remote control is possible through either a “duplicate desktop” mode or through a “virtual desktop” mode. In the duplicate desktop mode, the client computer displays a copy of the image received from the controlled (host) computer's display screen. The copy is updated on a timed interval, or when a change on the host computer screen is noticed by the remote control software. The software on the client computer transmits its own keyboard and mouse activity to the controlled computer, where the remote control software implements these actions. The controlled (host) computer then behaves as if the actions were performed directly at that computer. Examples of commercial applications of this technology include Symantec pcAnywhere, CrossTec Remote Control, Laplink, Carbon Copy, Apple Remote Desktop, Windows Timbuktu, and open source remote control software such as FreeNX.

“Virtual desktop” remote control software is used primarily to facilitate hardware-administration related tasks on a host computer without interrupting the activities of a user. This technology is primarily used so that a client computer may function as a duplicate desktop to accommodate a single user. Multiple clients may use a host computer, and individually view applications being run on the host computer on their individual desktop.

Glossary

Unless otherwise noted, or as may be evident from the context of their usage, any terms, abbreviations, acronyms or scientific symbols and notations used herein are to be given their ordinary meaning in the technical discipline t3o which the invention most nearly pertains. Abbreviations and acronyms (such as PDA, PAN, etc.) may be used throughout the descriptions presented herein and should be given their generally understood meaning within the field unless contradicted or elaborated upon by other descriptions set forth herein. Some of the terms set forth below may be registered trademarks (®).

As used herein, the term “Personal Area Network” or “PAN” means a computer network or configuration of computerized devices capable of communicating with each other within a defined geographical area (including but not limited to telephones, personal digital assistants, Bluetooth enabled devices, wireless and wired computer peripheral devices) close to one person. The devices may or may not belong to the person in question. The reach of a PAN is typically a few meters. PANs can be used for communication among the personal devices themselves (intrapersonal communication), or for connecting to a higher level network and the Internet.

As used herein, the term “client device” means any device on which Client Software may be hosted and which is capable of receiving a user input and emitting a client device output signal which may be received and interpreted by host software residing on a host computer. Examples of Client Devices include but are not limited to Personal Digital Assistants (PDAs), PDA, Tablet PCs, laptops, telephones, a wired or wireless computer mouse, a touchpad, a sensor, a device for reading bio-informatics data, bar and magnetic code sensors, a device conforming to Bluetooth or other industry standards. Client Devices may, but need not, include features such as touch screen for entering data, a memory card slot for data storage, connectivity using IrDA, Bluetooth and/or WiFi, a touch screen, using soft keys or keyboard emulating software components, a directional, numeric keypad or a thumb keyboard for input.

As used herein, the term “client software” means software that is capable of receiving user input from more than one user including but not limited to keystrokes, voice recognition data, movements detected by a sensor, motion of a mouse or any other input device, and which is further capable of transmitting a signal based on such input to a host computer to directing a function performed on the host computer.

As used herein, the term “collaborative task” means any task performed by a software application where the involvement, input or monitoring of more than one user is desirable.

As used herein, the term “host computer operating system” means software that manages the sharing of the resources of the host computer and performs basic tasks and serves as a platform for other computer applications.

As used herein, the term “host software” means software that is installed on a Host Computer and which is capable of receiving input from more than one device on which Client Software has been installed, and interpreting the signal to direct functions performed on the host computer. Examples of a function performed on the Host Computer include but are not limited to modifying or updating a user interface, modifying a document or modifying or initiating a process.

As used herein, the term “multi-user controller object” means a software object which manages Client Device Input (e.g., session objects) from more than one Client Device, and determines how computer resources will be allocated (e.g., “brokered”) to accommodate requests for computer resources. For example the Multi-user Controller Object may determine the priority of input processing from multiple client devices.

As used herein, the term “real time” means an operation which is performed and completed during a single session so as to provide a sense of continuity in the processing of the take or updating of the viewable interface to the user.

As used herein, the term “security manager object” means a software object which authenticates a user, manages the access parameters for a user, and performs authentication methods.

As used herein, the term “session object” or “unique session object” means code or instructions created to define methods and operations which can occur during the period of time or session that Client Software is connected to or in communication with Host Software. A session object may include data and functions to uniquely identify a client connection, track the state of a client connection, process input from a client, transmit data from Client Software Component to a Host Software Component, authentication methods, user attributes, device attributes, software application interface methods, security attributes and methods or attributes which facilitate communication between a Client and Host Software Component to complete a collaborative task.

As used herein, the term “user input” or “client input” means an action by a user which may be measured, detected or transmitted to a client device, including but not limited to keystrokes, voice recognition data, movements detected by a sensor, motion of a mouse, measurement by a device capable of reading bioinformatics data or any other user action capable of being detected and transmitted to a client.

### SUMMARY OF THE INVENTION

In various educational, business and other settings it is desirable for multiple users (e.g. a team or class) to view a single user interface and to collaboratively or simultaneously perform a collaborative task using a software application. Such collaborative tasks may include, but are not limited to editing or modifying a document, spread sheet, graphical image, visual interface, audio component, configuration of data, or functionality of the host computer.

It is desirable to have a method and system that facilitates collaboration by allowing more than one user to direct and view functions on a host computer by allowing more than one user to enter input (“collaborative input”) through more than one client device, so that it is not necessary for users to relinquish or transfer possession of a client device during a session.

It is further desirable to have a method and system which allows users to view the collaborative input on a user interface in real time.

It is further desirable to have an educational and/or training tool which permits a teacher or instructor to “show” the student or trainee how or where to enter data by gaining access to the user interface which the student or trainee is viewing by manipulating an additional client device, without requiring the student or trainee to transfer or relinquish the device.

It is further desirable to facilitate collaborative and group tasks by allowing each participating member to enter input using a separate client device and for a group or team of users to be able to view the collaborative input entered by each individual client device on a single user interface during one session, or over multiple sessions.

### BRIEF DESCRIPTION OF THE DRAWINGS

FIG. 1 is a flowchart of a method for collaborative multi-user task performance.

FIG. 2 is a flowchart of a method for collaborative multi-user task performance which includes client device authentication.

FIG. 3 is a diagram of collaborative multi-user system wireless system for operating a personal computer.

FIG. 4 is a diagram of collaborative multi-user system wireless system for operating a personal computer which includes security and authentication features.

### DETAILED DESCRIPTION OF THE DRAWINGS

For the purpose of promoting an understanding of the present invention, reference will be made to collaborative multi-user method and system. It is to be understood, however, that the present invention may be embodied in various forms. For example, elements and components of a system may be presented in varying manners, or steps of a method may be performed in a different order, and such representations are to be considered purely exemplary and representational of the elements or components which comprise the entire system, and not definitive of the order in which such components or elements perform a designated function.

Acts and symbolically represented operations or instructions may, but are not required to, include the manipulation of electrical or biological signals by a CPU, and all devices and peripherals on which software components may reside may be either wired or wireless devices in WANs, LANS and PANs, and may conform to any applicable industry standard for wired or wireless cabled, infra-red, signal emitting sensor technology, fiber-optic or other communication. It is recognized by those skilled in the art that industry standards, protocols and specifications change, and that variants in such standards are contemplated for use of the method and system described herein. Specific details and representations disclosed herein are not to be interpreted as limiting, but rather as a basis for the claims and as a representative basis for teaching one skilled in the art to employ the present invention. One of ordinary skill in the art will readily appreciate that modifications do not depart from the spirit and scope of the present invention, some of which are mentioned in the following description.

With particular reference to the figures, the reader should also know that like numerals in different figures may refer to the same elements of the embodiments. Moreover, it should be noted that each embodiment of the invention is not depicted by the figures. Steps of the methods can performed in any particular order, and devices and components may be configured in any manner or location with sufficient communication between the host and client software components of this system.

Data may be maintained on a computer readable medium including magnetic disks, optical disks, organic memory, and any other volatile (e.g., Random Access Memory [“RAM”]) or non-volatile (e.g., Read-Only Memory [“ROM”]) mass storage system readable by a CPU. The computer readable medium includes cooperating or interconnected computer readable media, which exist exclusively on the processing system to be distributed among multiple interconnected processing systems that may be local or remote to the processing system or may be maintained by an outside entity or source.

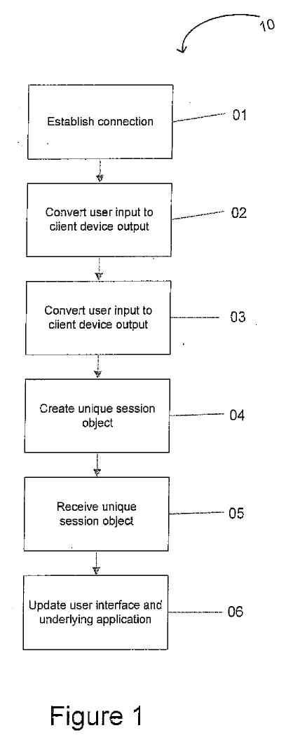

FIG. 1 is a flowchart of Method 10 for collaborative multi-user task performance which enables multiple users to submit input in furtherance of a task or project performed using a software application and to view user inputs and updates on a single user interface.

In the embodiment shown, Method 10 includes Step 01 of establishing multiple connections between a host computer and a client device operated by users who may create input in furtherance of a collaborate task. In the embodiment shown the client device is a Personal Digital Assistant (PDA). However, in other embodiments a client device may include other devices capable of creating output such as, PDAs, Tablet PCs, laptops, telephones, a wired or wireless computer mouse, a touchpad, a sensor, a device for reading bio-informatics data, bar and magnetic code sensors or any device conforming to Bluetooth or other industry standards.

In the embodiment shown, client software is installed on the client device. Also in the embodiment shown, host software is installed on a host computer. The host computer includes a user interface to display an application used to complete a collaborative task. In the exemplary embodiment, the software application used is a Microsoft Word application, and multiple users may collaborate to enter input in real time to edit a document using individually controlled client devices, and may view modifications and interface updates on a single user interface which reflects input from all users participating in the collaborative task. Other embodiments may be used for or in conjunction with other software applications which may be run on any operating system currently known in the art and installed on a host computer on which host software is installed.

In the embodiment shown, Method 10 further includes Step 02 receiving user input from more than one client device which is transmitted to client software installed on the client device. In the embodiment shown, user input consists of key strokes on a keyboard which are detected by the client device. In other embodiments, user input may include any actions by a user which may be measured, detected or transmitted to a client device, including but not limited to keystrokes, voice recognition data, reading of magnetic or bar code signals, movements detected by a sensor, motion of a mouse, measurement by a device capable of reading bio-informatics data or any other user action capable of being detected and transmitted to a client.

Step 03 includes converting the user input, converting said user input from a client device output which may be read by the host software to create an individual client-host connection to the host software for each client device.

Step 04 includes the step of creating a session object for each client device. The session object is created by host software running on the host computer. Each session object is unique to an individual client device controlled by an individual user. Each unique session object is received and invoked by the host software which is running on the host computer. In the embodiment shown, the session object identifies the user, identifies the functions of the software application that the user is authorized to perform, directs system and directs resources to make modifications or changes to the document being viewed by users participating in the collaborative task.

In the embodiment shown, the session object includes methods and attributes to create and display attributes (which may include attributes created by methods and functions) to associate modifications made to the user interface with a specific user generated by their individually controlled device. Exemplary display attributes (which may include attributes created by methods and functions), but are not limited to font size, color, annotation marks, graphical images, audible sounds, cursor color, cursor style, initialing, symbols, shading, highlighting and positioning. Other embodiments of the invention may, but need not include, methods within the unique session object which allow users to track changes, redline changes, highlight changes, modify text, modify graphical representation of data, correct text, correct data, assign a score, assign and/or track a weighted value, identify data subject to verification, identifying data for which user follow-up is required, embed or identify user questions, display user comments, create status bars, include notations identifying progress in completing a collaborative individual task and track individual user contributions and participation in the collaborative task being performed. Other embodiments may exclude these features or include more or fewer features, or features directed at accomplishing the same collaborative task objectives.

In one exemplary embodiment of Method 01, the host software receives a unique session object from each client device and accordingly displays a unique cursor on the user interface (distinguished by shape, color, etc.). The host software communicates with the operating system to display the multiple cursors, using commercially available Windows Messaging and Graphic functions.

In other embodiments of Method 01, a session object may include data and functions to uniquely identify a client connection, track the state of a client connection, process input from a client, transmit data from a Client Software Component to a Host Software Component, authentication methods, user attributes, device attributes, software application interface methods, security attributes and methods or attributes which facilitate communication between a Client and Host Software Component to complete a collaborative task or method or function related to a collaborative task.

Also shown in FIG. 1 is Step 05 host software invoking each unique session object by the host to create host software output which is communicated to the host computer operating system and used to updating a user interface and to update “underlying” software application which creates the user interface. Each client session object includes unique client identifiers that enable the host software to distinguish user input generated by each client device and direct the underlying software application accordingly. In one exemplary embodiment, a method performed at the wireless network layer, among different clients by their Internet Protocol (IP) addresses. In another exemplary embodiment the host software distinguishes different clients devices by Bluetooth connection channel. A multi-user input controller module manages Client Device Input (e.g., session objects) from more than one Client Device, and determines how computer resources will be allocated (e.g., “brokered”) to accommodate requests for computer resources. For example the Multi-user Controller Object may determine the priority of input processing from multiple client devices.

In another exemplary embodiment, host software may track client connections in its internal memory and may maintain a real-time list of client devices for which a connection to the host computer is currently active, or for which a connection has been terminated during a session. The real-time list may be a hash table or any other programming method known in the art.

Other embodiments may include a “split screen” feature, by which the host system is configured to allow one set of inputs to influence one program, while also accepting another set of inputs to influence another thus permitting multiple programs to be displayed (e.g. one program on one half of the computer screen and the other program on the other half);

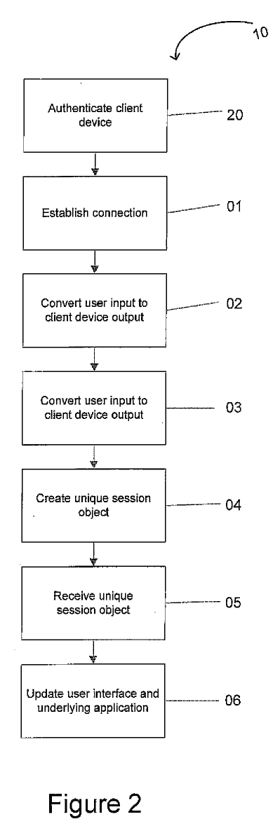

FIG. 2 illustrates an embodiment of method 10 which further includes Step 20 of authenticating a client device prior to accepting a client device output. In one exemplary embodiment, the application layer may include a method for processing client login information (e.g. a user name).

In an exemplary embodiment of the invention, the authenticating step is accomplished by configuring the host computer to identify and accept authorized Media Access Control (MAC) addresses, and may further include features that require password and login numbers to match the MAC addresses. In various embodiments of the invention, host software can be configured to allow or restrict access based on MAC access and/or login. Examples of levels of access or restricted access in various embodiments may include:
a. Full control
b. Certain types of inputs only e.g. keyboard input only, mouse input only
c. Certain times of the day when connections are allowed.
d. A combination of access levels, e.g. full access by any input from 8 AM to 5 PM CST, no access allowed from 5:01 PM to 7:59 AM.
e. Configuration to require approval of connections.

In other embodiments of the invention, communication data that flows between the client and host will be encrypted to such a degree that breaking the encryption would not be feasible, typically 128-bit encryption is considered acceptable.

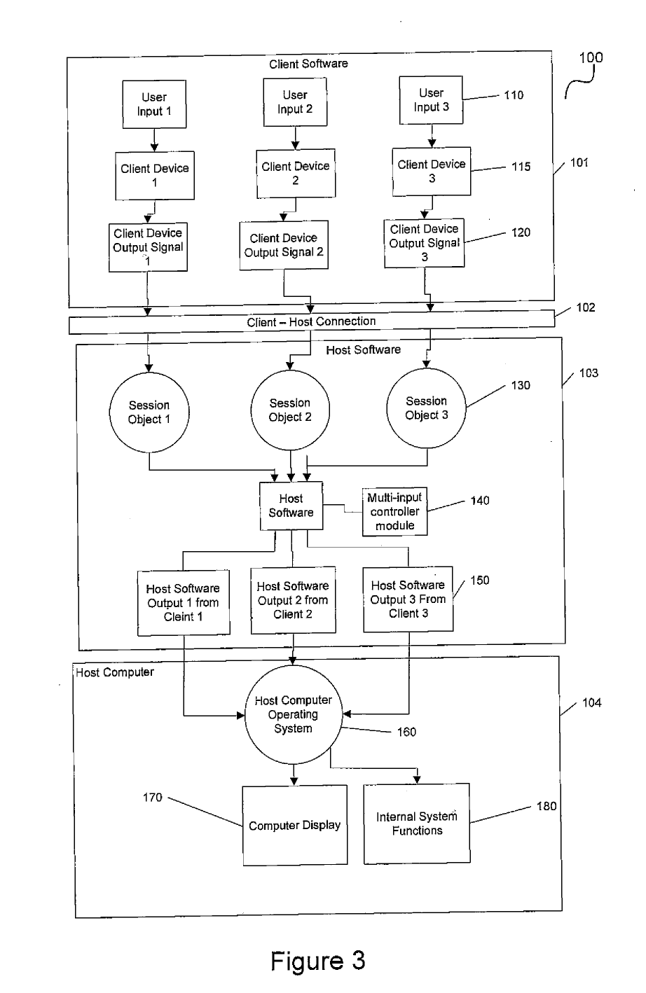

FIG. 3 is a diagram of a System 100 for facilitating collaborative task performance which includes client software 101 and host software 103 configured to establish a separate but simultaneous client-host connection 102 between two or more client devices 115 and host computer 104.

Client software 101 is configured to accept user input 110 from each client when transmitted or received separately from each client device 115, and to further generate a client device-output 120 which communicates with host software 103 to create a unique session object 130 for each client device 115 connected to host computer 104.

Each unique session object 130 generates host software output 150 capable of directing host computer operating system 160 to update computer display 170. In the embodiment shown, computer display 170 displays a user interface generated by a software application which the system allows to be accessed by multiple users to provide separate input through each individual client device 115 to update the user interface in real time. Additionally, internal system functions 180 of the host computer operating system and software applications that reside on it (and support the user interface) are updated.

In the embodiment shown Input from multiple client devices 115 are managed by multi-user input controller module 140 to make the operating system behave as if there are multiple keyboards, mice, or other input devices attached to the computer. The multiple inputs are processed thousands of times per second as the computer cycles through processing each input, giving each one it's allotted time slice. The host operating system processes input from the host operating system in the same manner as other host operating system commands. For example, in one embodiment using mouse/pointer type inputs, host software output 150 sends signals to operating system 160 in such a way as to make multiple cursors appear on the screen. In one exemplary embodiment, using a commercial graphic program, if a single client was connected to the host computer, the host computers mouse could paint with one color, while one or more client devices 115 could paint with another color to complete a collaborative graphics task.

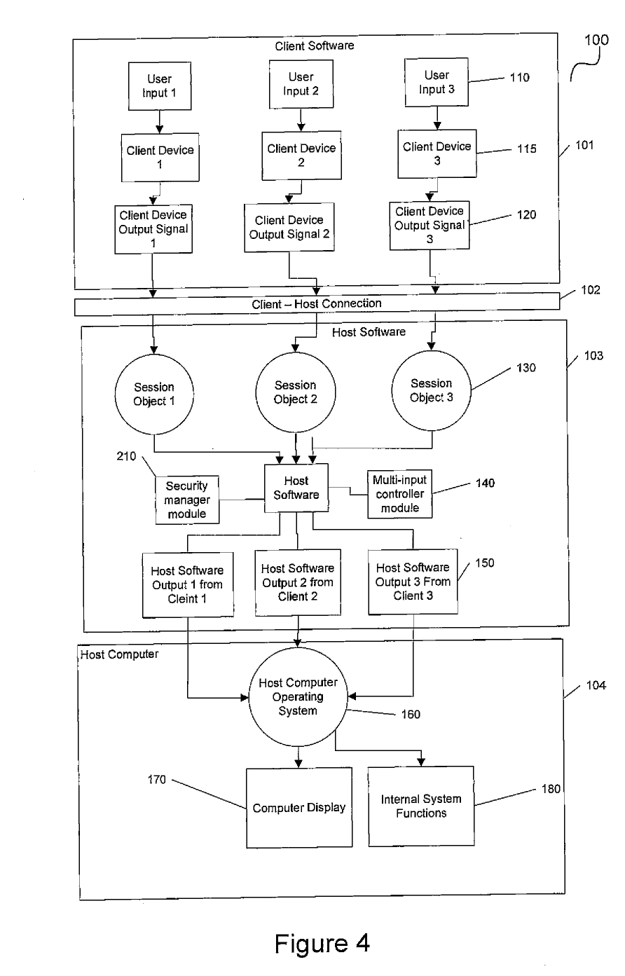

FIG. 4 is a diagram of a System 100 for facilitating collaborative task performance which further includes security management module 210 which provides client device authentication methods. Examples of such methods may include identifying and accepting authorized Media Access Control (MAC) addresses, requiring password and login numbers, and implementing levels of restricted access as identified supra.

What is claimed is:

1. A method of facilitating collaborative task performance comprising the steps of:
establishing a connection between client software residing on a client device and said host software residing on a host computer;
receiving user input from more than one client device and transmitting said user input to said client software;
converting said user input from said more than one client device into client device output which is capable of being interpreted by said host software;
creating a unique session object for each client device;
invoking said unique session object by said host software for said each client device to direct a host operating system; and
updating a user interface and software application residing on said host computer.

2. The method of claim 1, which further includes saving updates to said user interface to be displayed in a subsequent session.

3. The method of claim 1, which further includes assigning display attributes to identify modifications made by a specific user.

4. The method of claim 3, in which said display attributes assigned are selected from a group consisting of font size, color, annotation marks, graphical images, audible sounds, cursor color, cursor style, initialing, symbols, shading, highlighting and positioning).

5. The method of claim 1, wherein said user interface is updated to display features selected from a group consisting of tracked changes, redlined changes, highlighted changes, modified text, a modified graphical representation of data, corrected text, corrected data, an assigned score, magnetic image data, bar code data, an assigned weighted value, notations that data is subject to verification, notations that user follow-up is required, user questions, user comments, status bars, notations identifying progress in completing a collaborative individual task and notations identifying user contributions to a collaborative task.

6. The method of claim one which further includes the step of managing client device input to determine the priority of tasks when multiple tasks are initiated.

7. The method of claim 1 which further includes the step of authenticating a client device.

8. The method of claim 1 which further includes performing internal system functions, wherein said internal system functions are selected from a group consisting of updating a log, terminating a session, modifying data, saving data, saving a screenshot, backing up data, transmitting data, receiving updates, establishing session parameters and updating session parameters.

9. The method of claim 1 which further includes accepting user input to initiate a split screen feature.

10. A system for facilitating collaborative task performance comprising:
more than one client device configured with client software capable of reading a user input, establishing a connection with host software for each client device and communicating with said host software;
a host computer configured with said host software and including a host operating system resides configured with said host software capable of creating a unique session object for said each client device;
a multi-user controller module which manages said unique session objects; and
a user interface capable of interacting with software for performing a collaborative task.

11. The system of claim 10 which further includes a software component for authenticating a client device.

12. The system of claim 10 which further includes a software component which resides on said host computer for tracking client connections in the internal memory of said host computer.

13. The system of claim 11 wherein said software component is further configured to maintain a real-time list of client devices.

14. The system of claim 10 which further includes a software component to save said updates to said user interface to be displayed in a subsequent session.

15. The system of claim 10 which further includes a software component to assign display attributes to identify modifications made by a specific user.

16. The system of claim 10, in which said display attributes assigned are selected from a group consisting of font size, color, annotation marks, graphical images, audible sounds, cursor color, cursor style, initialing, symbols, shading, highlighting and positioning).

17. The systems of claim 1 which further includes a software component for performing internal system functions in response to said user input, wherein said internal system functions are selected from a group consisting of updating a log, terminating a session, modifying data, saving data, saving a screenshot, backing up data, transmitting data, receiving updates, establishing session parameters and updating session parameters.

18. The system of claim 10 which further includes a software module for accepting user input to initiate a split screen feature.

19. The system of claim 10 wherein said client software and said host software are further configured to receive and transmit encrypted data.

20. The system of claim 10 wherein said client software and said host software are further configured to receive and transmit voice recognition data.
